(19) United States
(12) Patent Application Publication
(10) Pub. No.: US 2015/0219446 A1
(43) Pub. Date: Aug. 6, 2015

(54) METHODS AND APPARATUSES FOR MEASURING VALUES OF PARAMETERS OF INTEGRATED CIRCUIT DEVICES

(71) Applicant: Samsung Electronics Co., Ltd., Suwon-si (KR)

(72) Inventors: Choon-Shik LEEM, Seoul (KR); Woo-Jin Jung, Seoul (KR); Ji-Hye Lee, Suwon-si (KR); Deok-Yong Kim, Gunpo-si (KR); Chul-Gi Song, Yongin-si (KR); Soo-Bok Chin, Seoul (KR)

(21) Appl. No.: 14/614,646

(22) Filed: Feb. 5, 2015

(30) Foreign Application Priority Data
Feb. 6, 2014 (KR) 10-2014-0013576

(51) Int. Cl. G01B 11/24; G01N 21/21

(52) U.S. Cl. CPC G01B 11/24; G01N 21/211; G01N 2021/213; G01N 2201/061; G01N 2201/12

(57) ABSTRACT

Methods and apparatuses for measuring parameters of integrated circuit devices may be provided. The methods may include performing detecting operations on samples to obtain a set of data. Each detecting operation may include irradiating a light beam to the samples using a light irradiation part and detecting reflected light from the samples using a light detector. The samples may have values of a parameter different from one another. The method may also include obtaining a principal component based on the set of data and obtaining a regression model for the parameter using the principal component and values of the parameter of the samples.

### CROSS-REFERENCE TO RELATED APPLICATION

This U.S. non-provisional patent application claims priority under 35 U.S.C. §119 to Korean Patent Application No. 10-2014-0013576, filed on Feb. 6, 2014, in the Korean Intellectual Property Office (KIP)), the disclosure of which is hereby incorporated by reference in its entirety.

### BACKGROUND

The present disclosure generally relates to the field of electronics, and more particularly, to methods and apparatuses for measuring parameters of integrated circuit devices.

An optical metrology may be used to measure properties (e.g., optical properties) or dimensions of patterns in a substrate in real time since it is non-destructive and contactless. For example, an optical metrology may be used determine a profile of a grating structure disposed on a substrate (e.g., semiconductor wafer).

A diffraction modeling technique, which is a type of optical metrology, may be used with a rigorous coupled wave analysis (RCWA) to analyze detected signals. The diffraction modeling technique may involve solving Maxwell's equations entailing a large number of complex calculations.

### SUMMARY

An optical measuring method may include performing a plurality of detecting operations on respective ones of a plurality of samples to obtain a set of data. Each one of the plurality of detecting operations may include irradiating a light beam to the respective ones of the plurality of samples using a light irradiation part and detecting reflected light from the respective ones of the plurality of samples using a light detector. Each of the plurality of samples may include a respective one of a plurality of structures therein, and a first one of the plurality of structures may include a parameter that may have a first value different from a second value of the parameter of a second one of the plurality of structures. The method may also include obtaining at least one principal component based on the set of data and obtaining values of the parameter of the plurality of structures. The method may further include performing a regression analysis to obtain a regression model that may regresses the at least one principal component to the values of the parameter of the plurality of structures.

According to various embodiments, each of the plurality of structures may include a grating structure, and the parameter may be a height of the grating structure

In various embodiments, the heights of the grating structures of the plurality of structures may have a first range that may be smaller than a range of heights of grating structures in mass-produced products.

According to various embodiments, performing the plurality of detecting operations may include obtaining the set of data including amplitude ratios and/or phase difference values according to a plurality of wavelengths of the reflected light.

In various embodiments, the plurality of wavelengths may include a N number of the plurality of wavelengths and obtaining the at least one principal component based on the set of data may include transforming the amplitude ratios and/or phase difference values to a K number of principal components using a Principal Component Analysis (PCA). K may be less than N.

In various embodiments, obtaining the at least one principal component based on the set of data may include obtaining a plurality of principal components and selecting one of the plurality of principal components that may have a highest correlation with the values of the parameter of the plurality of structures.

In various embodiments, performing the regression analysis may include performing a multiple linear regression (MLR) analysis.

According to various embodiments, the method may additionally include generating a recipe for estimating a value of the parameter using the at least one principal component and the regression model.

According to various embodiments, the method may further include estimating a value of the parameter of a target structure included in a mass-produced substrate using the recipe.

In various embodiments, the method may also include obtaining additional data to generate a new recipe by updating the recipe.

An optical measuring apparatus may include a stage configured to receive a substrate including a structure and an optical detection part, which may include a light irradiation part configured to irradiate a light beam on the substrate and a light detector configured to detect reflected light from the substrate and provide a set of data for a parameter of the structure. The apparatus may also include a calculation circuit connected to the optical detection part. The calculation circuit may include a first calculation circuit configured to output at least one principal component based on the set of data and a second calculation circuit configured to output a regression model, which may regresses the at least one principal component to determined values of the parameter.

According to various embodiments, the light detector may use spectroscopic ellipsometry and may be configured to obtain an amplitude ratio spectrum and/or phase difference spectrum. The set of data may include amplitude ratios and/or phase difference values according to a plurality of wavelengths obtained from the amplitude ratio spectrum and/or phase difference spectrum.

In various embodiments, the plurality of wavelengths may include a N number of the plurality of wavelengths, and obtaining the at least one principal component based on the set of data may include transforming the amplitude ratios and/or phase difference values to a K number of principal components using a principal component analysis (PCA). K may be less than N.

According to various embodiments, the second calculation circuit may be configured to perform a multiple linear regression (MLR) analysis to output the regression model.

In various embodiments, the calculation circuit may further include a recipe generation circuit that may be configured to generate a recipe for estimating a value of the parameter using the at least one principal component and the regression model.

A measuring method may include performing a plurality of detecting operations on respective ones of a plurality of samples to obtain a set of data. Each one of the plurality of detecting operations may include irradiating a light beam to the respective ones of the plurality of samples using a light irradiation part to generate reflected light from each of the respective ones of the plurality of samples and detecting the reflected light from the each of the respective ones of the plurality of samples using a light detector. A first one of the plurality of samples may have a parameter that may have a first value different from a second value of the parameter of a second one of the plurality of samples. The method may also include obtaining a principal component based on the set of data and obtaining a regression model for the parameter of the plurality of samples using the principal component and determined values of the parameter of the plurality of samples.

In various embodiments, the method may further include generating a formula using the regression model. The formula may provide relation between the set of data and the determined values of the parameter of the plurality of samples.

According to various embodiments, the light irradiation part may include a first light irradiation part, and the light detector may include a first light detector. The method may further include irradiating a light beam to a substrate including a pattern therein using a second light irradiation part, detecting reflected light from the substrate using a second light detector to obtain data and estimating a third value of the parameter of the pattern using the formula and the data.

According to various embodiments, performing the plurality of detecting operations may include obtaining the set of data including amplitude ratios and/or phase differences of the reflected light according to a plurality of wavelengths using the light detector.

In various embodiments, the light detector may use spectroscopic ellipsometry.

### BRIEF DESCRIPTION OF THE DRAWINGS

FIG. 1 is a flowchart illustrating methods in accordance with example embodiments of the present inventive concept.

FIG. 2 is a diagram illustrating an apparatus in accordance with example embodiments of the present inventive concept.

FIGS. 3A, 4A and 5B are diagrams illustrating samples in accordance with example embodiments of the present inventive concept.

FIGS. 3B, 4B and 5B are plan views of samples in accordance with example embodiments of the present inventive concept.

FIG. 6 is a graph illustrating respective spectrums obtained from the samples of FIGS. 3A, 4A and 5A.

FIGS. 7A and 7B are graphs illustrating a transformation of a coordinate system in accordance with example embodiments of the present inventive concept.

### DETAILED DESCRIPTION

Example embodiments are described herein with reference to the accompanying drawings. Many different forms and embodiments are possible without deviating from the spirit and teachings of this disclosure and so the disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected to or coupled to the other element or layer or intervening elements or layers may be present. In contrast, when an element or layer is referred to as being “directly on,” “directly connected to” or “directly coupled to” another element or layer, there are no intervening elements or layers present. Like reference numbers refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section could be termed a second element, component, region, layer or section without departing from the teachings of this disclosure.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes,” and “including,” when used in this specification, specify the presence of stated features, steps, operations, elements, and/or components, but do not preclude the presence or addition of one or more other features, steps, operations, elements, components, and/or groups thereof.

Example embodiments of the present inventive concept are described herein with reference to diagrams that are schematic illustrations of the embodiments. As such, variations from the shapes of the illustrations as a result, for example, of manufacturing techniques and/or tolerances, are to be expected. Thus, example embodiments of the present inventive concept should not be construed as limited to the particular shapes illustrated herein but may include deviations in shapes that result.

It should also be noted that in some alternate implementations, the functions/acts noted in flowchart blocks herein may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Other blocks may be added or inserted between the blocks that are illustrated, or blocks/operations may be omitted without departing from the scope of the disclosure.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, example embodiments will be explained with reference to the accompanying drawings.

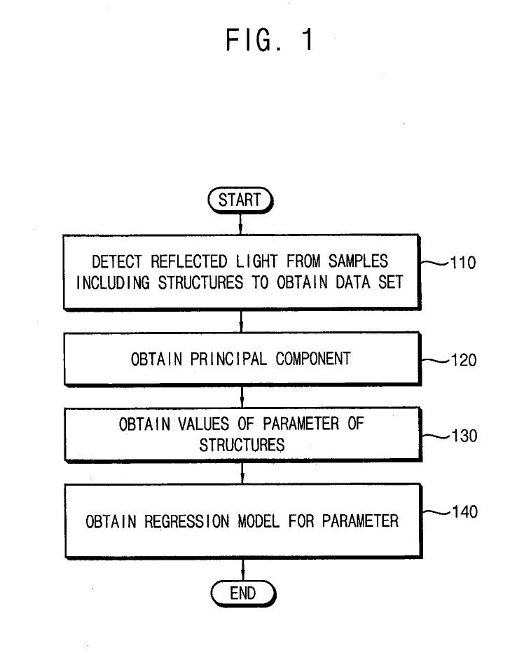

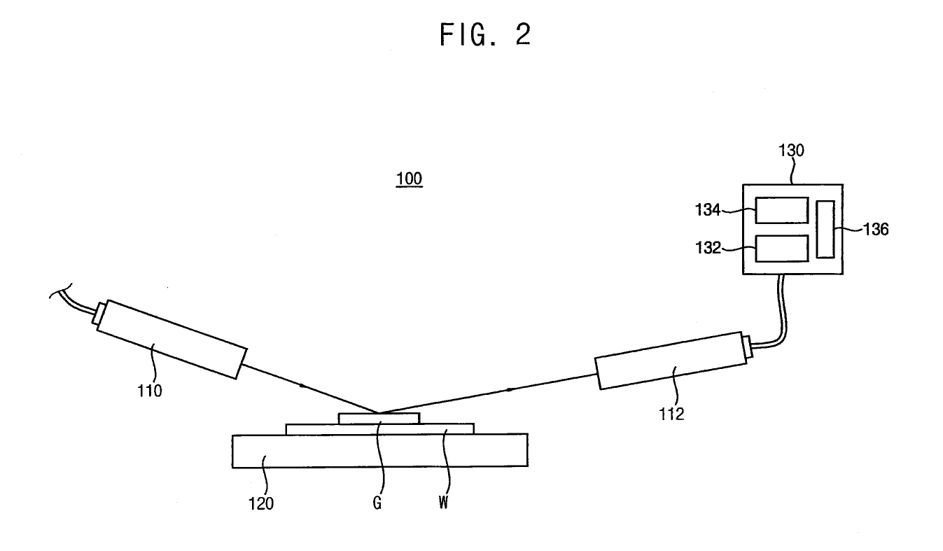

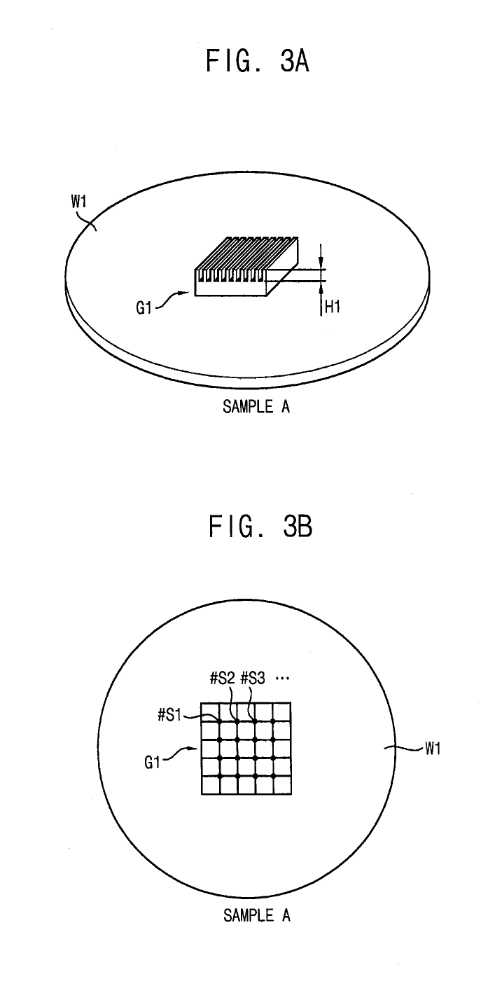

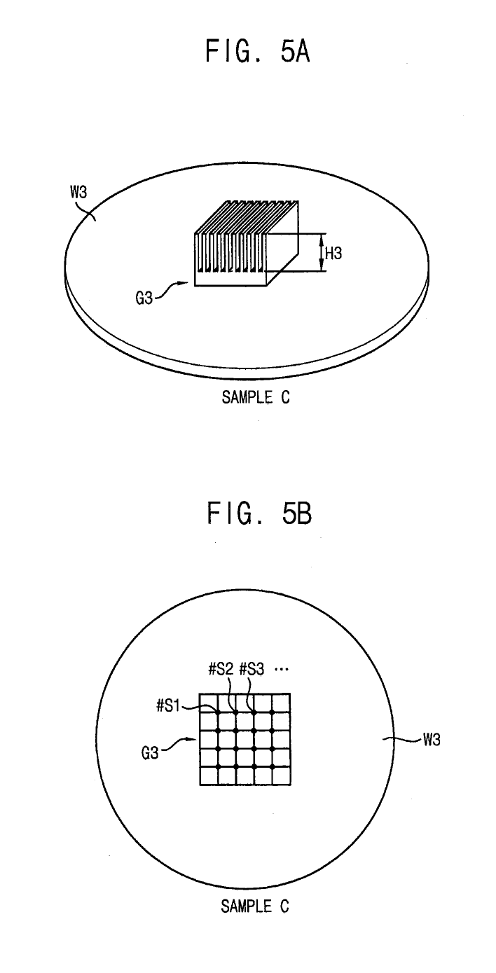

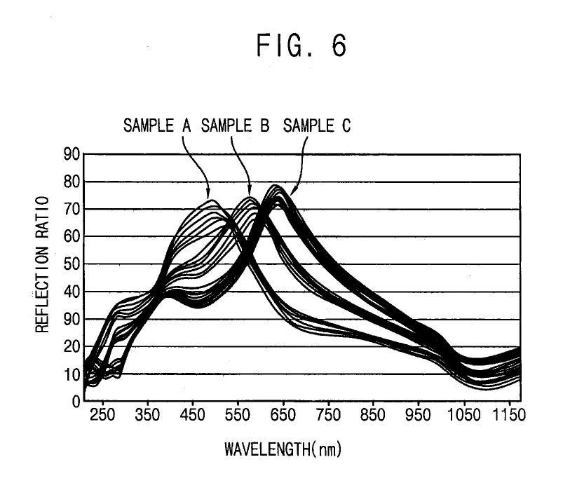

FIG. 1 is a flowchart illustrating methods in accordance with example embodiments of the present inventive concept. FIG. 2 is a diagram illustrating an apparatus in accordance with example embodiments of the present inventive concept. FIGS. 3A, 4A and 5B are diagrams illustrating respective samples in accordance with example embodiments of the present inventive concept. FIGS. 3B, 4B and 5B are plan views of samples in accordance with example embodiments of the present inventive concept. FIG. 6 is a graph illustrating respective spectrums obtained from the samples of FIGS. 3A, 4A and 5A.

Referring to FIGS. 1 to 6, manufacturing processes for integrated circuit devices (e.g., semiconductor devices such as a Dynamic Random Access Memory (DRAM) or Nonvolatile memory devices including NAND and Vertical NAND) can be monitored using a measuring method. For example, the measuring method may be an optical measuring method.

As illustrated in FIG. 2, a measuring apparatus 100 may perform a measuring method in accordance with example embodiments of the present inventive concept to measure at least one parameter of a structure G (e.g., grating structure) disposed on a substrate W (e.g., wafer). For example, the parameter may be a dimensional parameter. The measuring apparatus 100 may be an optical measuring apparatus that is configured to perform an optical measuring method. For example, the parameter may define a profile or shape of the structure G and may include a width, a height, a sidewall angle, etc.

The optical measuring apparatus 100 may include a stage 120 that may receive and/or support a substrate W (e.g., wafer) including a structure of interest G (e.g., a grating structure). The substrate W may be, for example, a sample that may not be a mass-produced product. In some embodiments, the substrate W may be a mass-produced product. The optical measuring apparatus 100 may also include an optical detection part, which may include a light irradiation part 110 and a light detector 112, and a calculation circuit 130. The light irradiation part 110 may irradiate a light beam on the substrate W, and the light detector 112 may detect a reflected light from the substrate W. The calculation circuit 130 may be connected to the optical detection part 110 and 112 and may be configured to perform a statistical analysis and to generate a recipe for estimating a dimensional parameter of the structure of interest.

Hereinafter, a method for measuring a parameter of a structure in a substrate in accordance with example embodiments of the present inventive concept will be discussed.

In some embodiments, the method may use a plurality of samples including respective ones of a plurality of grating structures G therein.

For example, the plurality of samples may include three samples A, B and C, as illustrated in FIGS. 3A, 4A and 5A, respectively. It will be understood that a number of the samples may be one, two or more than three. Referring to FIGS. 3A, 4A and 5A, the sample A may include a first grating structure Q1, the sample B may include a second grating structure G2, and the sample C may include a third grating structure G3. The first to third grating structures G1, G2 and G3 may have the same dimensions except one parameter (i.e., parameter of interest). The parameter of interest may be predetermined before the samples A, B and C are prepared. In some embodiments, the first to third grating structures G1, G2 and G3 may have more than two parameters of interest, which have different values among the first to third grating structures G1, G2 and G3.

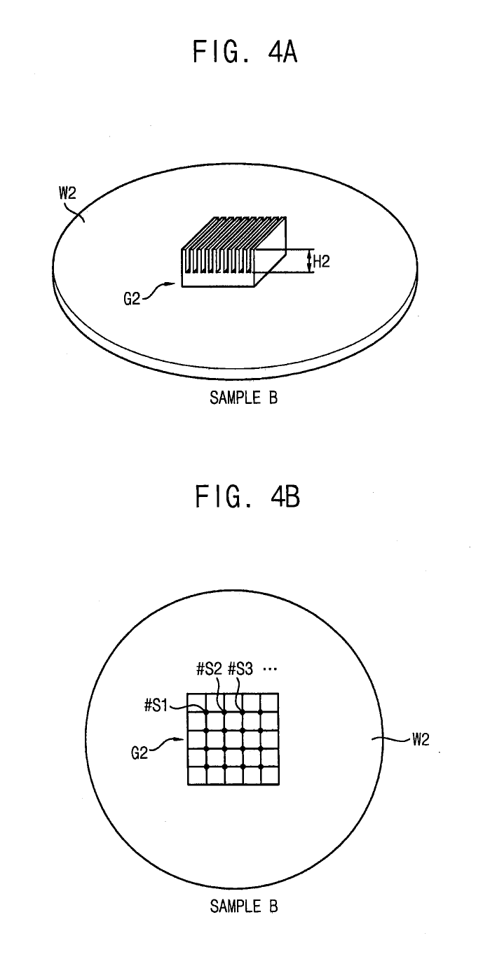

For example, the parameter of interest may be heights of the grating structures included in the respective samples A, B and C, and the samples A, B and C may have the same dimensions except the heights of the grating structures. In some embodiments, the samples A, B and C may be wafers on which manufacturing processes are performed to form layers including the grating structures. FIGS. 3A, 4A and SA show the samples A, B and C on different wafers, it will be understood, however, that in some embodiments the grating structures G1, G2 and G3 may be disposed in a single substrate (e.g., wafer). Stated in other words, the samples A, B and C may be included on a single substrate. Referring to FIGS. 3A, 4A and 5A, the first grating structure G1 of the first sample A may have a first height H1, the second grating structure G2 of the second sample B may have a second height H2 greater than the first height H1, and the third grating structure G3 of the third sample C may have a third height H3 greater than the second height H2.

In some embodiments, values of a parameter of structures in samples (i.e., not mass-provided products) may have a first range that is smaller than a second range of values of the parameter of mass-produced products. For example, the heights H1, H2 and H3 of the first, second and third grating structures G1, G2 and G3 in the samples A, B and C may have a first range that is smaller than a second range of heights of grating structures in mass-produced products.

The method in accordance with example embodiments may include detecting reflected light from the samples A, B, C to obtain a data set (Block 110).

As illustrated in FIG. 2, the optical measuring apparatus 100 may include the light detector 112. In some embodiments, the samples A, B and C may be placed on the stage 120 and the light irradiation part 110 may irradiate a light beam to the samples A, B and C. For example, the light detector 112 may use spectroscopic ellipsometry. The light detector 112 may detect reflected light from the samples A, B and C to obtain a reflection ratio spectrum of s and p components into which the light incident upon the samples A, B and C may be decomposed. The light detector 112 may output the amplitude ratio (e.g., tan(ψ)) spectrum and/or phase difference (e.g., A) spectrum.

As illustrated in FIGS. 3B, 4B, 5B and 6, a first group of the amplitude ratio spectrums according to wavelengths may be obtained at a first set of positions (e.g., #S1, #S2, #S3, . . . ) of the first sample A, a second group of the amplitude ratio spectrums according to wavelengths may be obtained a second set of positions (e.g., #S1, #S2, #S3, . . . ) of the second sample B, and a third group of amplitude ratio spectrums according to wavelengths may be obtained at a third set of positions (e.g., #S1, #S2, #S3, . . . ) of the third sample C. In some embodiments, a number of the positions may be ten or more. However, the number of the positions may not be limited thereto. It will be understood that the first, second and third set of positions (e.g., #S1, #S2, #S3, . . . ) may be substantially the same positions or different from one another.

The first to third groups of the amplitude ratio spectrums may be spectrum groups corresponding to several different grating heights, including a wafer-to-wafer distribution and/or variation and a site-to-site distribution and/or variation in the wafer. It will be understood that the spectrums may change linearly according to a change of a specific parameter.

For example, the data set obtained from the amplitude ratio spectrums may be a set of amplitude ratio values according to wavelengths at specific positions of the samples. The amplitude ratio values may be distributed across a plurality of wavelengths corresponding to a change of a parameter (e.g., a height of a grating structure).

The method in accordance with example embodiments may also include obtaining at least one principal component based on the data set (Block 120). In some embodiment, the at least one principal component may be obtained using a principal component analysis (PCA).

As illustrated in FIG. 2, a first calculation circuit 132 may output the at least one principal component based on the data set. In some embodiments, the first calculation circuit 132 may output the at least one principal component of the data set by performing a PCA on the data set.

Table 1 provides principal components that the first calculation circuit 132 may output.

TABLE 1

| | Detection | Data Set | Principal components |
|---|---|---|---|
| SAMPLE | Position | (λ1 λ2 . . . λk . . . λn) | (λ1′ λ2′ . . . λk′ . . . λn′) |
| A | #S1 | λ_{A1}1 λ_{A1}2 . . . λ_{A1}k . . . λ_{A1}n | λ_{A1}1′ λ_{A1}2′ . . . λ_{A1}k′ . . . λ_{A1}n′ |
| (Height | #S2 | λ_{A2}1 λ_{A2}2 . . . λ_{A2}k . . . λ_{A2}n | λ_{A2}1′ λ_{A2}2′ . . . λ_{A2}k′ . . . λ_{A2}n′ |
| H1) | #S3 | λ_{A3}1 λ_{A3}2 . . . λ_{A3}k . . . λ_{A3}n | λ_{A3}1′ λ_{A3}2′ . . . λ_{A3}k′ . . . λ_{A3}n′ |
| | . . . | . . . | . . . |
| B | #S1 | λ_{B1}1 λ_{B1}2 . . . λ_{B1}k . . . λ_{B1}n | λ_{B1}1′ λ_{B1}2′ . . . λ_{B1}k′ . . . λ_{B1}n′ |
| (Height | #S2 | λ_{B2}1 λ_{B2}2 . . . λ_{B2}k . . . λ_{B2}n | λ_{B2}1′ λ_{B2}2′ . . . λ_{B2}k′ . . . λ_{B2}n′ |
| H2) | #S3 | λ_{B3}1 λ_{B3}2 . . . λ_{B3}k . . . λ_{B3}n | λ_{B3}1′ λ_{B3}2′ . . . λ_{B3}k′ . . . λ_{B3}n′ |
| | . . . | . . . | . . . |
| C | #S1 | λ_{C1}1 λ_{C1}2 . . . λ_{C1}k . . . λ_{C1}n | λ_{C1}1′ λ_{C1}2′ . . . λ_{C1}k′ . . . λ_{C1}n′ |
| (Height | #S2 | λ_{C2}1 λ_{C2}2 . . . λ_{C2}k . . . λ_{C2}n | λ_{B2}1′ λ_{B2}2′ . . . λ_{B2}k′ . . . λ_{B2}n′ |
| H3) | #S3 | λ_{C3}1 λ_{C3}2 . . . λ_{C3}k . . . λ_{C3}n | λ_{C3}1′ λ_{C3}2′ . . . λc3k′ . . . λ_{C3}n′ |
| | . . . | . . . | . . . |

In the data set, each one of the wavelengths (w1, w2, . . . , wn) may be referred to as a variable, a single specific position may be represented by amplitude ratio values (λ1, λ2, . . . , λk, . . . , λn) corresponding to several tens to hundreds of variables. Accordingly, the data set may be n dimensional data set (λ1, λ2, . . . , λk, . . . , λn), and n is a natural number.

For example, the reflection ratio spectrum obtained at a test position of a sample may include amplitude ratio values (λ1, λ2, . . . , λk, . . . , λn) corresponding to the respective wavelengths (w1, w2, . . . , wn).

Accordingly, a first site (e.g., #S1) of the sample A (height H1) may be represented by amplitude ratio values (λ_{A1}1, λ_{A1}2, . . . , λ_{A1}k, . . . , λ_{A1}n) corresponding to the respective wavelengths (w1, w2, . . . , wn). A second site (e.g., #S2) of the sample A (height H1) may be represented by amplitude ratio values (λ_{A2}1, λ_{A2}2, . . . , λ_{A2}k, . . . , λ_{A2}n) corresponding to the respective wavelengths (w1, w2, . . . , wn). A third site (e.g., #S3) of the sample A (height H1) may be represented by amplitude ratio values (λ_{A3}1, λ_{A3}2, . . . , λ_{A3}k, . . . , λ_{A3}n) corresponding to the respective wavelengths (w1, w2, . . . , wn).

A first site (e.g., #S1) of the sample B (height H2) may be represented by amplitude ratio values (λ_{B1}1, λ_{B1}2, . . . , λ_{B1}k, . . . , λ_{B1}n) corresponding to the respective wavelengths (w1, w2, . . . , wn). A second site (e.g., #S2) of the sample B (height H2) may be represented by amplitude ratio values (λ_{B2}1, λ_{B2}2, . . . , λ_{B2}k, . . . , λ_{B2}n) corresponding to the respective wavelengths (w1, w2, . . . , wn). A third site (e.g., #S3) of the sample B (height 112) may be represented by amplitude ratio values (λ_{B3}1, λ_{B3}2, . . . , λ_{B3}k, . . . , λ_{w}n) corresponding to the respective wavelengths (w1, w2, . . . , wn).

A first site (e.g., #S1) of the sample C (height H3) may be represented by amplitude ratio values (λ_{C1}1, λ_{C1}2, . . . , λ_{C1}k, . . . , λ_{C1}n) corresponding to the respective wavelengths (w1, w2, . . . , wn). A second site (e.g., #S2) of the sample C (height H3) may be represented by amplitude ratio values (λ_{C2}1, λ_{C2}2, . . . , λ_{C2}k, . . . , λ_{C2}n) corresponding to the respective wavelengths (w1, w2, . . . , wn). A third site (e.g., #S3) of the sample C (height H3) may be represented by amplitude ratio values (λ_{C3}, λ_{C3}2, . . . , λ_{C3}k, . . . , λ_{C3}n) corresponding to the respective wavelengths (w1, w2, . . . , wn).

It will be understood that in the data set, the wavelengths (w1, w2, . . . , wn) may be variables, and the variables may have a strong correlation therebetween. For example, the amplitude ratio values at adjacent wavelengths may represent a linear change pattern according to a change of the wavelength. That is, a change of the spectrum corresponding to a change of a specific parameter may represent a linear change for each wavelength. Accordingly, in some embodiments, a PCA may be performed on the data set to find variation patterns in the optical data set of high dimension.

Referring to Table 1, when the data set is n dimensional data set having n number of variables (wavelengths), a PCA may be performed on the data set to find principal component vectors perpendicular to each other.

The amplitude ratio values at each one of the wavelengths (w) may be referred to as λ1, λ2, . . . , λn) respectively, the principal component vectors may be used to find a coordinate transformation matrix {Aij} for a new variable (w′), which may transform the data to a new coordinate system. The matrix {Aij} may be written in the following matrix Equation 1.

$$( \begin{matrix}{a}_{11} & {a}_{12} & {a}_{13} & ⋯ & {a}_{1 n} \\ {a}_{21} & {a}_{22} & & & \\ {a}_{31} & & ⋱ & & \\ ⋮ & & & & \\ {a}_{n 1} & & & & {a}_{nn}\end{matrix} ) ( \begin{matrix}{λ}_{1} \\ {λ}_{2} \\ {λ}_{3} \\ ⋮ \\ {λ}_{n}\end{matrix} ) = ( \begin{matrix}{a}_{11} {λ}_{1} + {a}_{12} {λ}_{2} + {a}_{13} {λ}_{3} + ⋯ + {a}_{1 n} {λ}_{n} \\ ⋮ \\ \\ \\ {a}_{n 1} {λ}_{1} + {a}_{n 2} {λ}_{2} + {a}_{n 3} {λ}_{3} + ⋯ + {a}_{nn} {λ}_{n}\end{matrix} ) = ( \begin{matrix}{λ}_{1}^{′} \\ {λ}_{2}^{′} \\ {λ}_{3}^{′} \\ ⋮ \\ {λ}_{n}^{′}\end{matrix} ) \qquad [ Equation 1 ]$$

The method in accordance with example embodiments may further include obtaining values of the parameter of the structure (Block 130). It will be understood that the values of the parameter may be determined values once the values are obtained. In some embodiments, the values of the parameter may be obtained by measuring the parameter of the structures (e.g., height of a grating structure in the samples A, B and C). In some embodiments, the values of the parameter may be determined before the samples A, B and C are prepared. It will be further understood that the determined values of the parameter of the structures may be considered as reference data because the values may be considered actual values of the dimensional parameter of the structure.

In some embodiments, the values of the parameter of the structures may be obtained at specific positions (e.g., #S1, #S2, #S3, . . . ) of the samples A, B and C using a destructive testing tool (e.g., a Scanning Electron Microscope (SEM) and a Transmission Electron Microscope (TEM)). A number of the specific positions may be, for example, ten or more. However, the number of the specific positions may not be limited thereto.

Additionally, the method in accordance with example embodiments may include obtaining a regression model for the parameter (Block 140). The regression model may be obtained by performing a regression analysis. The regression model may provide a function describing a relationship between principal components and reference data (e.g., values of a parameter of structures). In some embodiments, the regression model may regress the principal components on the reference data.

As illustrated in FIG. 2, a second calculation circuit 134 may perform a multiple linear regression (MLR) analysis to find a linear model, which may regress the principal components on the reference data. The linear model may be provided as Equation 2. The MLR analysis may be performed to find constants a, b, c, . . . , m in Equation 2 while reducing or possibly minimizing an estimation error. In some embodiments, the constants a, b, m may be determined to reduce or possibly minimize an estimation error.

f(λ₁′, λ₂′, λ₃′, - - - , λₙ′)=a+bλ₁′cλ₂′+dλ₃′+ . . . +mλₙ′ [Equation 2]

Table 2 provides the principal components and the measured heights of the grating structures. The heights may be obtained using a destructive testing tool.

TABLE 2

| | | | Measurement values |
|---|---|---|---|
| | Detection | Principal components | (e.g., heights of grating |
| SAMPLE | Position | (λ1′ λ2′ . . . λk′) | structures) |
| A | #S1 | λ_{A1}1′ λ_{A1}2′ . . . λ_{A1}k′ | R_{A1} |
| (Height | #S2 | λ_{A2}1′ λ_{A2}2′ . . . λ_{A2}k′ | R_{A2} |
| H1) | #S3 | λ_{A3}1′ λ_{A3}2′ . . . λ_{A3}k′ | R_{A3} |
| | . . . | . . . | . . . |
| B | #S1 | λ_{B1}1′ λ_{B1}2′ . . . λ_{B1}k′ | R_{B1} |
| (Height | #S2 | λ_{B2}1′ λ_{B2}2′ . . . λ_{B2}k′ | R_{B2} |
| H2) | #S3 | λ_{B3}1′ λ_{B3}2′ . . . λ_{B3}k′ | R_{B3} |
| | . . . | . . . | . . . |
| C | #S1 | λ_{C1}1′ λ_{C1}2′ . . . λ_{C1}k′ | R_{C1} |
| (Height | #S2 | λ_{B2}1′ λ_{B2}2′ . . . λ_{B2}k′ | R_{C2} |
| H3) | #S3 | λ_{C3}1′ λ_{C3}2′ . . . λc3k′ | R_{C3} |
| | . . . | . . . | . . . |

Referring to Tables 1 and 2, a method in accordance with example embodiments of the present inventive concept may include obtaining principal components from reflection ratio and/or phase difference values according to wavelengths and obtaining a linear model using the principal components and reference data. In some embodiments, a number of the wavelengths may be n and a number of the principal components may be k, and k may be smaller than n. In some embodiments, the linear model may be obtained, for example, using a multiple linear regression (MLR) analysis.

In some embodiments, a first principal component vector of the n principal component vectors may have a largest possible variance of the data distribution and may be considered as a most significant principal component vector. The principle components may be used to reduce a number of the variables and may leave only several variables. The principal components may be arranged in descending order of variance, and the size of the vector (i.e., a number of the principal components) may thus be reduced.

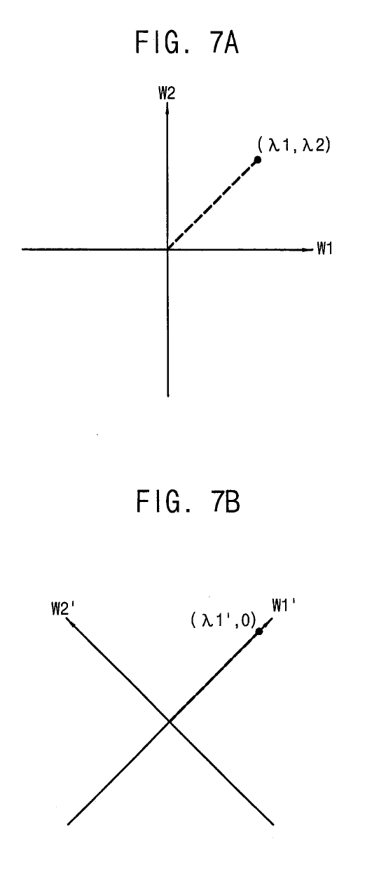

FIGS. 7A and 7B are graphs illustrating a transformation of a coordinate system in accordance with example embodiments of the present inventive concept. In some embodiments, the transformation may be performed using a Principal Component Analysis (PCA).

Referring to FIGS. 7A and 7B, an object at (λ1, λ2) in a (w1, w2) coordinate system in FIG. 7A may be transformed into (λ1′, 0) in the transformed coordinate system (w1′, w2′) in FIG. 7B. Accordingly, a number of variable vector coordinates may be reduced by transforming the coordinate system.

Referring again to Table 2, in some embodiments, a reduced set of principal components may be obtained after the principal components are obtained from the samples A, B and C. A regression analysis may be performed on the reduced set of principal components. Regression models including the principal components may be provided as Equation 3 through Equation 11.

a+bλ_{A1}1′+cλ_{A1}2′+ . . . +lλ_{A1}k′=R_{A1} [Equation 3]

a+bλ_{A2}1′+cλ_{A2}2′+ . . . +lλ_{A2}k′=R_{A2} [Equation 4]

a+bλ_{A3}1′+cλ_{A3}2′+ . . . +lλ_{A3}k′=R_{A3} [Equation 5]

. . .

a+bλ_{B1}1′+cλ_{B1}2′+ . . . +lλ_{B1}k′=R_{B1} [Equation 6]

a+bλ_{B2}1′+cλ_{B2}2′+ . . . +lλ_{B2}k′=R_{B2} [Equation 7]

a+bλ_{B3}1′+cλ_{B3}2′+ . . . +lλ_{B3}k′=R_{B3} [Equation 8]

. . .

a+bλ_{C1}1′+cλ_{C1}2′+ . . . +lλ_{C1}k′=R_{C1} [Equation 9]

a+bλ_{C2}1′+cλ_{C2}2′+ . . . +lλ_{C2}k′=R_{C2} [Equation 10]

a+bλ_{C3}1′+cλ_{C3}2′+ . . . +lλ_{C3}k′=R_{C3} [Equation 11]

. . .

In the equations, the constants a, b, c, . . . , l may be determined, for example, by performing a regression analysis.

The method in accordance with example embodiments may include selecting at least one of the principal components having high correlation with the actual measurements.

In some embodiments, a recipe may be obtained using the principal components and the regression model. The recipe may be used to estimate a parameter of a target structure included in a mass-produced product.

As illustrated in FIG. 2, the calculation circuit 130 may further include a recipe generation circuit 136 connected to the first calculation circuit 132 and the second calculation circuit 134. The recipe generation circuit 136 may generate a recipe for estimating a parameter using the principal components and the regression model. In some embodiments, the recipe generation circuit 136 may generate a formula using the regression model, and the formula may provide relation between data set and values of the dimensional parameter.

For example, the recipe may be used to estimate a parameter of a new sample including a structure disposed on a mass-produced product (e.g., wafer).

Specifically, a light beam may be irradiated onto a mass-produced product including a structure and reflected light may be detected to obtain a reflection ratio spectrum and/or phase difference spectrum, and then a data set of reflection ratio values and/or phase difference values according to a plurality of wavelengths may be obtained.

A parameter (e.g., a height of a grating structure) of a structure in a mass-produced substrate may be estimated using the recipe. Specifically, principal components may be obtained based on data set and a linear model may be used to estimate a value of the parameter of a structure in a mass-produced substrate. The principal components may be obtained using a PCA.

There may be an estimation error when a structure of interest is changed. In some embodiments, new data may be additionally obtained and analyzed to update the recipe such that a new recipe is generated for measuring the parameter of the original structures and the changed structure.

When the changed structure is similar to the original structures, new data may be additionally obtained to correct the current recipe and to generate a new recipe capable of estimating a value of a parameter from spectrums of the original and changed structures.

Integrated circuit devices (e.g., semiconductor devices such as DRAM, NAND and Vertical NAND) may be measured using a measuring method and a measuring apparatus in accordance with example embodiments during manufacturing processes. The integrated circuit devices may be included in computing systems. The computing systems may be, for example, computer, portable computer, laptop computer, personal digital assistant, tablet, mobile phone, MP3 player, etc. In some embodiments, the measuring method may be an optical measuring method, and the measuring apparatus may be an optical measuring apparatus.

According to a measuring method and a measuring apparatus in accordance with example embodiments, spectrums may be obtained from samples using an optical detection part, a statistical analysis may be used to provide a regression model, which may provide relation between the spectrum and determined values of a parameter of interest. For example, the statistic analysis may include a PCA and a multiple linear regression analysis. The determined values of the parameter of interest may be measured values and/or predetermined values. A recipe may be generated from the regression model. The recipe may be used to estimate a parameter of a structure on a mass-produced substrate. The structure may be a 3-dimensional structure.

In some embodiments, a test site for measuring a 3-dimensional structure may not be formed, and a cell array of a semiconductor memory device may thus be measured. Further, it will be understood that a recipe set-up time may be reduced thereby reducing or possibly minimizing costs for measurements and server investments for model optimization calculation. Still further, there may be an estimation error when a structure of interest is changed. When the changed structure is similar to original structure, new data may be additionally obtained to correct the current recipe and to generate a new recipe capable of estimating a value of a dimensional parameter from spectrums of the original and changed structures

In some embodiments, the light irradiation part 110 of the optical measuring apparatus 100 of FIG. 2 may include an X-ray source, and the light detector 120 may use X-ray diffractiometry (XRD). Diffracted light from samples may be detected to obtain diffraction spectrums according to respective incident angles (θ). A data set may be obtained from the diffraction spectrums. The data set may be a set of diffraction intensity values according to the respective incident angles. In the data set, each one of the incident angles (θ1, θ2, . . . , θn) may be variables, and specific positions may be represented by intensity valves (I1, I2, . . . , Ik, . . . , In) corresponding to several tens to hundreds of variables. Principal components may be obtained based on the data set obtained from the diffraction spectrums and a regression analysis may be performed to generate a recipe for estimating a parameter of interest. The principal components may be obtained using a PCA.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope is to be determined by the broadest permissible interpretation of the following claims and their equivalents, and shall not be restricted or limited by the foregoing detailed description.

What is claimed is:

1. An optical measuring method, the method comprising:
performing a plurality of detecting operations on respective ones of a plurality of samples to obtain a set of data, wherein:
each one of the plurality of detecting operations comprises irradiating a light beam to the respective ones of the plurality of samples using a light irradiation part and detecting reflected light from the respective ones of the plurality of samples using a light detector;
each of the plurality of samples comprises a respective one of a plurality of structures therein; and
a first one of the plurality of structures comprises a parameter that has a first value different from a second value of the parameter of a second one of the plurality of structures;
obtaining at least one principal component based on the set of data;
obtaining values of the parameter of the plurality of structures; and
performing a regression analysis to obtain a regression model that regresses the at least one principal component to the values of the parameter of the plurality of structures.

2. The method of claim 1, wherein each of the plurality of structures comprises a grating structure, and the parameter is a height of the grating structure.

3. The method of claim 2, wherein the heights of the grating structures of the plurality of structures have a first range that is smaller than a range of heights of grating structures in mass-produced products.

4. The method of claim 1, wherein performing the plurality of detecting operations comprises obtaining the set of data comprising amplitude ratios and/or phase difference values according to a plurality of wavelengths of the reflected light.

5. The method of claim 4, wherein:
the plurality of wavelengths comprises a N number of the plurality of wavelengths;
obtaining the at least one principal component based on the set of data comprises transforming the amplitude ratios and/or phase difference values to a K number of principal components using a Principal Component Analysis (PCA); and
K is less than N.

6. The method of claim 1, wherein obtaining the at least one principal component based on the set of data comprises:
obtaining a plurality of principal components; and
selecting one of the plurality of principal components that has a highest correlation with the values of the parameter of the plurality of structures.

7. The method of claim 1, wherein performing the regression analysis comprises performing a multiple linear regression (MLR) analysis.

8. The method of claim 1, further comprising generating a recipe for estimating a value of the parameter using the at least one principal component and the regression model.

9. The method of claim 8, further comprising estimating a value of the parameter of a target structure included in a mass-produced substrate using the recipe.

10. The method of claim 1, further comprising obtaining additional data to generate a new recipe by updating the recipe.

11. An optical measuring apparatus, the apparatus comprising:
a stage configured to receive a substrate including a structure;
an optical detection part comprising a light irradiation part configured to irradiate a light beam on the substrate and a light detector configured to detect reflected light from the substrate and provide a set of data for a parameter of the structure; and
a calculation circuit connected to the optical detection part, the calculation circuit comprising a first calculation circuit configured to output at least one principal component based on the set of data and a second calculation circuit configured to output a regression model, which regresses the at least one principal component to determined values of the parameter.

12. The optical measuring apparatus of claim 11, wherein:
the light detector uses spectroscopic ellipsometry and is configured to obtain an amplitude ratio spectrum and/or phase difference spectrum; and
the set of data comprises amplitude ratios and/or phase difference values according to a plurality of wavelengths obtained from the amplitude ratio spectrum and/or phase difference spectrum.

13. The optical measuring apparatus of claim 12, wherein:
the plurality of wavelengths comprises a N number of the plurality of wavelengths; and
obtaining the at least one principal component based on the set of data comprises transforming the amplitude ratios and/or phase difference values to a K number of principal components using a principal component analysis (PCA); and
K is less than N.

14. The optical measuring apparatus of claim 13, wherein the second calculation circuit is configured to perform a multiple linear regression (MLR) analysis to output the regression model.

15. The optical measuring apparatus of claim 11, wherein the calculation circuit further comprises a recipe generation circuit that is configured to generate a recipe for estimating a value of the parameter using the at least one principal component and the regression model.

16. A measuring method, the method comprising:
performing a plurality of detecting operations on respective ones of a plurality of samples to obtain a set of data, wherein:
each one of the plurality of detecting operations comprises irradiating a light beam to the respective ones of the plurality of samples using a light irradiation part to generate reflected light from each of the respective ones of the plurality of samples and detecting the reflected light from the each of the respective ones of the plurality of samples using a light detector; and
a first one of the plurality of samples has a parameter that has a first value different from a second value of the parameter of a second one of the plurality of samples;
obtaining a principal component based on the set of data; and
obtaining a regression model for the parameter of the plurality of samples using the principal component and determined values of the parameter of the plurality of samples.

17. The measuring method of claim 16, further comprising generating a formula using the regression model, the formula providing relation between the set of data and the determined values of the parameter of the plurality of samples.

18. The measuring method of claim 17, wherein:
the light irradiation part comprises a first light irradiation part, and the light detector comprises a first light detector; and
the measuring method further comprises:
irradiating a light beam to a substrate including a pattern therein using a second light irradiation part;
detecting reflected light from the substrate using a second light detector to obtain data; and
estimating a third value of the parameter of the pattern using the formula and the data.

19. The measuring method of claim 16, wherein performing the plurality of detecting operations comprises obtaining the set of data comprising amplitude ratios and/or phase differences of the reflected light according to a plurality of wavelengths using the light detector.

20. The measuring method of claim 19, wherein the light detector uses spectroscopic ellipsometry.
